(19) United States
(12) Patent Application Publication
(10) Pub. No.: US 2006/0069454 A1
(43) Pub. Date: Mar. 30, 2006

(54) Control system

(76) Inventor: Keith Burnham, Coventry (GB)

Correspondence Address: Paul Y Feng;Fulwider Patton Lee & Utecht, Howard Hughes Center, 6060 Center Drive Tenth Floor, Los Angeles, CA, 90045, US

(21) Appl. No.: 10/547,096

(22) PCT Filed: Mar. 1, 2004
(86) PCT No.: PCT/GB04/00852

§ 371 Date: Aug. 26, 2005

(30) Foreign Application Priority Data
Feb. 28, 2003 (GB) 0304561.4

(51) Int. Cl. G05B 13/02

(52) U.S. Cl. 700/45; 700/28; 700/37

(57) ABSTRACT

A compensating controller for controlling a non-linear parameter of an industrial process in a control system for said process comprises means (106) for producing a weighted linear response, means (108, 24) for producing a weighted non-linear response, and summation means (112) for summing the weighted responses to produce an optimal controller response.

### FIELD OF THE INVENTION

The present invention relates to a control system, in particular a bilinear structured control system, for controlling an industrial process or plant.

### DESCRIPTION OF THE PRIOR ART

Many industrial processes and plant such as, for example, an industrial gas-fired re-heat furnace, exhibit complex, non-linear characteristics and require control systems which have a considerable degree of flexibility and sophistication in order to provide optimum control of the processes and plant. Where the performance of the process or plant is not critical, control of the process or plant can be effected by linear three term PID (proportional, integral and derivative) control. However, there are many situations where performance is critical and such control is rendered inadequate.

GB A 2336447 to Coventry University describes a control system for controlling an operating parameter of an industrial process in which the response of the parameter is assumed to be bilinear. The system has a feedback circuit for providing a feedback signal which is representative of the value of the parameter to be controlled and a referenced signal generator for providing a reference signal which represents a desired value of the parameter. A. comparator compares the two signals and generates an error signal in response to the comparison signal, and a control circuit provides a control signal as a function of both the error signal and also taking into account the non-linearity of the system response, in order to adjust the parameter. Hence the control signal is a bilinear function of the feedback signal.

### BRIEF SUMMARY OF THE INVENTION

The present invention seeks to provide an improved control system for controlling an industrial process or plant.

According to one aspect of the present invention there is provided a compensating controller for controlling a non-linear parameter of an industrial process in a control system for said process, the controller comprising means for producing a weighted linear response, means for producing a weighted non-linear response, and first summation means for summing the weighted responses to produce a controller response.

The means for producing a weighted non-linear response may include weighting means for producing a weighted output and a function generator for producing a non-linear response.

Preferably the compensating controller further comprises first time shifting means for producing a first time-shifted output, the time-shifted output representing an input signal shifted by at least one unit of time.

Preferably the means for producing a weighted non-linear response further comprises; difference means for comparing the time shifted output with the weighted output to produce a differential output; and second summation means for summing the time shifted output with the non-linear response to produce a second summed output.

The weighting means may be configured to input the weighted output into the function generator and the function generator may be configured to generate the weighted non-linear response for summation by the first summation means.

Preferably the compensating controller is configured to input a feedback signal into the function generator and the non-linear response of the function generator is a function of the feedback signal.

The feedback signal may be a time-shifted version of at least one output of the industrial process.

Preferably the compensating controller includes a decision making unit for selecting the relative weights for the weighted responses dependant on input signals, the input signals including at least one reference signal and at least one output from the industrial process.

The input signals may also include at least one input from a supervisory system.

The decision making unit may be part of a supervisory system.

According to another aspect of the present invention there is provided a method of controlling a non-linear parameter of an industrial process comprising: producing a weighted linear response having a first weighting value; producing a weighted non-linear response having a second weighting value; and summing the weighted responses to produce a controller response.

Preferably the method includes controlling the weighting values to provide an optimal controller response.

The weighting values may be any value between and including zero and one.

### BRIEF DESCRIPTION OF THE DRAWINGS

The present invention is further described hereinafter, by way of example, with reference to the accompanying drawings, in which:

FIG. 1 is a graph showing the variation in energy throughput for a linear and bilinear control system for an industrial plant;

FIG. 2 is a schematic representation of a first embodiment of control system according to the present invention for an industrial plant; and

FIG. 3 is a schematic representation of a second embodiment of control system according to the present invention for an industrial plant.

The applicant's prior patent GB 2336447 discloses a control system for an industrial plant such as a high temperature furnace, for example an industrial gas-fired re-heat furnace. The control system controls the opening of a gas valve of the furnace in order to regulate the temperature to a desired temperature profile. The operation of the furnace is controlled by means of an auto-tuned industrial PID (proportional, integral and derivative) and a control module which allows for automatic compensation of the non-linearity of the plant operation. For a full description of the operation of the control system the reader is directed to GB 2336447.

The aim of the non linear compensating controller described in GB 2336447 is to achieve consistency in terms of transient performance over a specified range, rather than a point, as is the case of a linear controller. The controller of GB 2336447 effectively achieves this by linearising the system to be controlled, thus making the existing PID linear controller more effective.

However, implementation of the controller described in GB 2336447 requires an iterative tuning procedure.

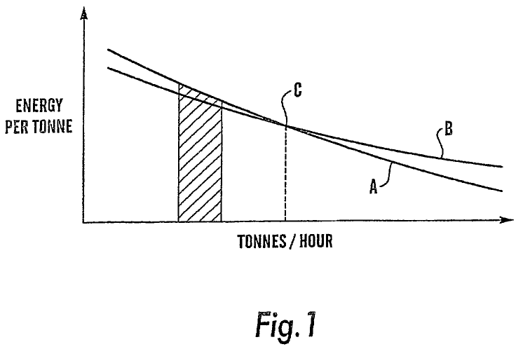

Use of the system of GB 2336447 may in some circumstances lead to improved consistency at the expense of increased energy usage. Whilst there may be an overall energy saving, the usage of energy for low throughput (i.e. tonnes per hour) in a continuously operated furnace may well increase. FIG. 1 is a graph showing the variation in energy per tonne against tonnes per hour for both a bilinear system (curve A) and a linear system (curve B). The area under each curve is a measure of the power used and as can be seen, in the example shown in FIG. 1 the linear system uses less power at fuel feed rates below the system tuning point C and more power at fuel feed rates above the system tuning point. This relationship could, of course, be different for different plants and systems.

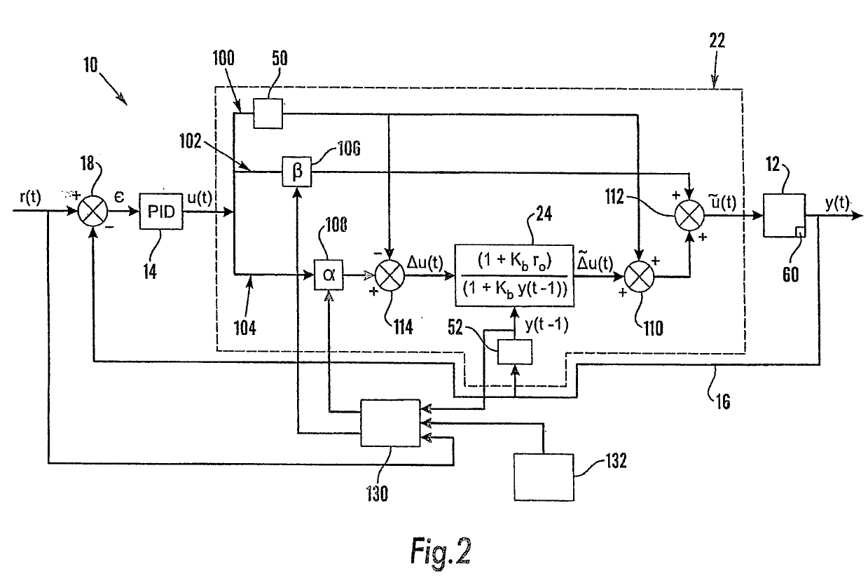

FIG. 2 shows a preferred form of control system 10 according to the present invention for an industrial plant 12 such as a high temperature furnace, for example an industrial gas-fired re-heat furnace. (Note that in the following, reference is made to a gas-led system. The following could equally be applied to an air-led system, with the term “gas valve” being replaced by “air flow”.) The control system 10 in this particular example controls the opening of a gas valve of the furnace in order to regulate the temperature to a desired temperature profile.

The system of FIG. 2 has an auto-tuned industrial PID (proportional, integral and derivative) controller 14 whose input is connected to a summing circuit 18 which in turn receives a control signal r(t). The controller 14 provides an output in the form of a control signal u(t) which is applied to an input of a control unit 22. The control unit 22 provides a modified control signal ũ (t) which is applied to the plant 12.

A sensor 60 provides an output signal representative of the output parameter being monitored (in this case the temperature) and the signal is fed back along a feedback path 16 to the summing circuit 18. The summing circuit 18 compares the feedback value with the desired set point reference signal r(t) and applies an error signal ε to the PID controller 14 in dependence on the comparison.

The output from the controller 14 is applied to the input of the control unit 22 and is fed along three separate paths 100, 102, 104.

The first path 100 contains a backward shift operator 50 which shifts the input signal back one unit in time. The operator 50 can be effected using a store. Where the PID 14 provides a digital output signal the operator 50 stores each signal and transmits the immediately preceding signal to a summing circuit 110. Where the output signal of the PID 14 is an analogue signal then the operator 50 can also include a sampling circuit which samples the signal u(t) at discrete intervals and again applies the immediately preceding sampled signal to the summing circuit 110.

The second path 102 contains a weighting module 106 which applies a weighting value β to the received control signal u(t) and applies the resulting weighted signal to a further summing circuit 112. The summing circuit 112 applies the modified control signal ũ (t) to the plant 12.

The third path 104 contains a second weighting module 108 which applies a waiting factor α to the signal from the controller 14. The resulting weighted signal is then applied to a difference circuit 114 which also receives the output of the operator 50. The difference circuit 114 compares the two input signals and provides an output signal Δ(t) which is a signal representing the change in the value of u(t) over the sampling period effected by the operator 50 (where u(t) is an analogue signal) or the difference between successive signals (where u(t) is a digital signal). This difference signal Δu(t) is then applied to a controller or function generator 24 which provides an output signal \tilde{Δ} u (t) which is applied to the summing circuit 110.

The relationship between \tilde{Δ} u (t) and Δu(t) is set out below.

$${\tilde{Δ} u ( t ) = Δ u ( t ) \frac{( 1 + {K}_{b} {r}_{o} )}{( 1 + {K}_{b} y ( t - 1 ) )}}^{}$$

where:
K_{b} is a tuning parameter.
rₒ is the reference value at the point of tuning.
y(t−1) is a feedback signal backward shifted by one unit of time (sample period).

The summing circuit 110 sums the outputs of the controller 24 and the operator 50 and applies the result to the summing circuit 112 to provide the modified output control signal \tilde{μ} (t).

The feedback signal from the plant 12 along the feedback path 16 is also applied to the controller 24 via backward shift operator 52. Thus the feedback path 16 applies a feedback signal y(t−1) to the controller 24.

The weighting modules 106 and 108 are controlled by means of a decision making unit 130 which receives the feedback signal y(t−1), the reference control signal r(t) and a further signal from a supervisory control and data acquisition system (SCADA 132) which is an overseeing system which looks at the overall plant operation and generates a controlling signal in dependence thereon.

The weighting values α and β can be varied between 0 and 1 by the decision making unit 130 in dependence on specific parameters, for example, energy efficiency or consistency or any such compromise between such parameters as is required. For example, if the value of β is zero then no signal is applied to the summing circuit 112 through path 102. Thus the signal u(t) is not applied directly to the circuit 112. Control is therefore effected by the controller 24. However, if the value of α is zero then the path 104 is open and the controller 24 is not effective. Control is therefore effected only by the PID controller 14. Referring to FIG. 1, the area under the graph is power used and if energy efficiency is required then the linear curve B above the tuning point is used and the bilinear curve A below the tuning point is used. This means that above the tuning point α is zero and β is 1. These values are reversed to the left of the tuning point.

For consistency in the quality of production then α is 1 and β is zero. For energy efficiency, a is zero and β is 1.

It will also be appreciated that the values of α and β can be varied continuously or in a stepwise manner between zero and 1 by the system to provide different weightings in dependence on the compromise required between energy efficiency and consistency.

A typical example of SCADA 132 is “In-Touch” produced by Wonderware Corporation of California, USA.

The decision making unit 130 could actually be part of the SCADA 132 but could equally be separate and in the form of a switch which is manually actuated or actuated by or in dependence on the signal from the SCADA 132.

The control signal from the SCADA 132 which is applied to the decision making unit 130 can be in the form of one or more signals representing one or more off-line parameter settings which are based on required performance.

These parameter settings can be provided by a management information system whose objective is to take financial decisions at a higher level than the loop level control scheme of FIG. 2.

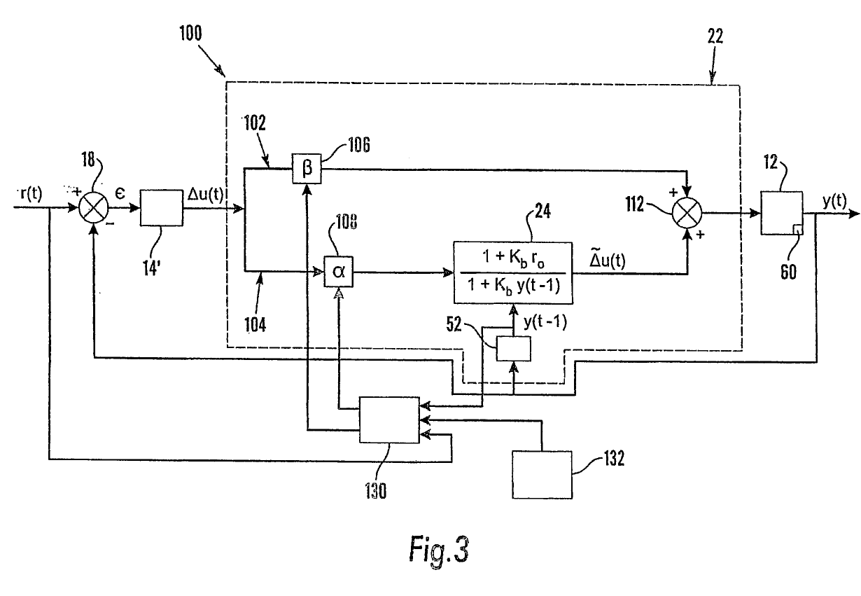

Referring to FIG. 3, this is a diagram, similar to that of FIG. 2, showing a second embodiment of control system 100 according to the present invention. Like parts with FIG. 2 are given like reference numbers.

The significant difference between FIGS. 2 and 3 is that in FIG. 3 the path 100, and therefore the summing circuit 110, is omitted. This is possible because the PID controller 14′ provides an output signal Δu(t) which is representative of the incremental change in the control signal u(t) provided by the PID controller of 14 of FIG. 2. This apart, the system of FIG. 3 operates in the same manner as the system of FIG. 2.

Note that control unit 22 is basically a digital control system. As such, it operates on and produces sampled data signals i.e. signals that are held constant for each sample period and are updated every sample period.

If the control unit 22 is incorporated in a control system that uses or generates analogue signals i.e. those that are continuous in amplitude and time (for example when it is part of a retrofit system) which are needed by unit 22, then it should be understood that operators 50 and 52 and weighting modules 106 and 108 would incorporate appropriate sample and whole circuitry to convert the said analogue signals to digital ones suitable for control unit 22. In some cases a signal sample and hold circuit may be used to provide more than one digital input into the unit 22.

1. A compensating controller for controlling a non-linear parameter of an industrial process in a control system for said process, the controller comprising:
means for producing a weighted linear response;
means for producing a weighted non-linear response; and
first summation means for summing the weighted responses to produce a controller response.

2. A compensating controller as claimed in claim 1 wherein the means for producing a weighted non-linear response include weighting means for producing a weighted output and a function generator for producing a non-linear response.

3. A compensating controller as claimed in claim 2 wherein the compensating controller further comprises first time shifting means for time-shifted output, the time-shifted output representing an input signal shifted by at least one unit of time.

4. A compensating controller as claimed in claim 3 wherein the means for producing a weighted non-linear response further comprises:
difference means for comparing the time shifted output with the weighted output to produce a differential output; and
second summation means for summing the time shifted output with the non-linear response to produce a second summed output.

5. A compensating controller as claimed in claim 2 wherein the weighting means is configured to input the weighted output into the function generator and the function generator is configured to generate the weighted non-linear response for summation by the first summation means.

6. A compensating controller as claimed in claim 2 wherein the compensating controller is configured to input a feedback signal into the function generator and the non-linear response of the function generator is a function of the feedback signal.

7. A compensating controller as claimed in claim 6 wherein the feedback signal is a time-shifted version of at least one output of the industrial process.

8. A compensating controller as claimed in claim 1 wherein the compensating controller includes a decision making unit 3 for selecting the relative weights for the weighted responses dependant on input signals, the input signals including at least one reference signal and at least one output from the industrial process.

9. A compensating controller as claimed in claim 8 wherein the input signals include at least one input from a supervisory system.

10. A compensating controller as claimed in claim 8 wherein the decision making unit is part of a supervisory system.

11. A method of controlling a non-linear parameter of an industrial process comprising:
producing a weighted linear response having a first weighting value;
producing a weighted non-linear response having a second weighting value;
summing the weighted responses to produce a controller response.

12. A method as claimed in claim 11 further comprising controlling the weighting values to provide an optimal controller response.

13. A method as claimed in claim 11 wherein the weighting values are any value between and including zero and one.
